(19) United States
(12) Patent Application Publication
(10) Pub. No.: US 2026/0361020 A1
(43) Pub. Date: Nov. 12, 2026

(54) CABLE-END CONNECTOR AND CONNECTOR ASSEMBLY

(71) Applicant: Bellwether Electronic (Kunshan) Co., Ltd., Jiangsu (CN)

(72) Inventors: Xiang-Biao TANG, Jiangsu (CN); Dongjin GU, Jiangsu (CN)

(21) Appl. No.: 19/260,307

(22) Filed: Jul. 4, 2025

(30) Foreign Application Priority Data
May 12, 2025 (CN) 202510605693.5

(51) Int. Cl. H01R 13/52; H01R 13/422; H01R 13/506; H01R 13/512

(52) U.S. Cl. CPC H01R 13/5202; H01R 13/4223; H01R 13/506; H01R 13/512; H01R 13/5208

(57) ABSTRACT

A connector assembly includes a cable-end connector and a mating connector. The cable-end connector includes a housing, a conductive base, a cable, a rear barrel, a waterproof member and a stopping member. The housing is tubular. The conductive base is within the housing. The cable is partially within the housing and electrically connected to the conductive base. The rear barrel is coupled to the housing and defines a waterproof space with the housing. The rear barrel surrounds the cable. The waterproof member is within the housing and surrounds the cable. The stopping member is within the housing, abuts the conductive base, and surrounds the cable. The stopping member and the rear barrel are respectively located on opposite sides of the waterproof member and limit the waterproof member in an axial direction. The housing compresses the waterproof member in a direction perpendicular to the axial direction.

### CROSS-REFERENCE TO RELATED APPLICATION

This application claims priority to China Application Serial Number 202510605693.5, filed May 12, 2025, which is herein incorporated by reference in its entirety.

### BACKGROUND

### Field of Invention

The present invention relates to a connector assembly. More particularly, the present invention relates to a cable-end connector and a connector assembly.

### Description of Related Art

During the development of electrical connectors, as important interfaces for power or signal transmission, it is crucial to design and consider how to achieve stable mechanical connection and reliable electrical conduction between cable-end connectors and their mating connectors. In early designs, it is common to rely on simple physical engagements for connections so as to ensure that the connection between the cable-end connector and the mating connector is stable, so that the electrical connection between terminals could also be stable.

However, when electronic devices are used outdoors or in humid environments, water or moisture may infiltrate the cable-end connectors, leading to short circuits, signal transmission interruptions, or even equipment damage. These issues have consistently been annoying to users. Although some designers have noticed such needs and attempted to take some basic measures on improving the connection interfaces, the waterproof performance is not good enough. Therefore, current cable-end connectors cannot be used under extreme environments.

Therefore, how to improve the waterproof performance of cable-end connectors and ensure their reliability in various environments has been a goal in related technical fields.

### SUMMARY

To solve aforementioned problems, the present disclosure provides a connector assembly including a cable-end connector and a mating connector. The cable-end connector includes a first housing, a second housing, a conductive base, a first waterproof member, a second waterproof member, a first stopping member, a second stopping member and a rear barrel. The mating connector includes a front barrel. The first housing has a tubular shape. The conductive base is located within the first housing. The first waterproof member surrounds an outer peripheral surface of the first housing. The second housing surrounds the outer peripheral surface of the first housing. The first stopping member surrounds the outer peripheral surface of the first housing. The first stopping member and the second housing are located on opposite sides of the first waterproof member respectively in an axial direction and cooperatively limit the first waterproof member therebetween. At least one cable is electrically connected to the conductive base. The second waterproof member has at least one receiving hole. The second stopping member has at least one through-hole. The rear barrel has at least one through-hole. The receiving hole is aligned with the at least one through-hole of the second stopping member and the through-hole of the rear barrel, such that the at least one cable is configured to sequentially pass through the rear barrel, the second waterproof member, and the second stopping member. The front barrel is detachably connected to the first housing. The front barrel and the first housing define a waterproof space, and the front barrel surrounds the first housing and the first waterproof member. An inner wall of the front barrel is configured to apply force to the first waterproof member in a direction perpendicular to the axial direction.

The present disclosure also provides a cable-end connector including a housing, a conductive base, a cable, a rear barrel, a waterproof member, and a stopping member. The housing has a tubular shape. The conductive base is located within the housing. The cable is at least partially located within the housing and is electrically connected to the conductive base. The rear barrel is coupled to the housing. The rear barrel and the housing define a waterproof space. The rear barrel surrounds the cable. The waterproof member is located within the housing and surrounds the cable. The stopping member is located within the housing and abuts the conductive base. The stopping member surrounds the cable. The stopping member and the rear barrel are respectively located on opposite sides of the waterproof member in an axial direction and cooperatively limit the waterproof member therebetween in the axial direction, and the housing is configured to compress the waterproof member in a direction perpendicular to the axial direction.

The present disclosure also provides another cable-end connector including a housing, a conductive base, a conductive plug, a cable, a waterproof member, a lateral barrel, and a stopping member. The housing includes a sleeve portion extending from a lateral side of the housing. The conductive base is located within the housing. The conductive plug is located within the sleeve portion and is electrically connected to the conductive base. The cable is at least partially located within the sleeve portion and is electrically connected to the conductive plug. The waterproof member is located within the sleeve portion and surrounds the cable. The lateral barrel is coupled to the sleeve portion. The lateral barrel and the sleeve portion define a waterproof space. The lateral barrel surrounds the cable. The stopping member is located within the sleeve portion and abuts the conductive plug. The stopping member surrounds the cable. The stopping member and the lateral barrel are respectively located on opposite sides of the waterproof member in an axial direction and cooperatively limit the waterproof member therebetween in the axial direction. The sleeve portion is configured to compress the waterproof member in a direction perpendicular to the axial direction.

In summary, according to the cable-end connector of the present disclosure, the waterproof components can be stably fixed and compressed by multiple elements, such as multi-layered housings, annular sealing structures, barrels (the front barrel, the rear barrel, or the lateral barrel), and stopping members, in multiple directions, thereby providing an improved and effective sealing and waterproofing means.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective schematic view of a connector assembly according to some embodiments of the present disclosure.

FIG. 2 is a perspective schematic view of the connector assembly of FIG. 1 from another viewing angle.

FIG. 3 is an exploded view of the connector assembly of FIG. 1.

FIG. 4 is a perspective schematic view of a cable-end connector of the connector assembly of FIG. 1.

FIG. 5 is a cross-sectional view taken along the section line A1 in FIG. 1.

FIG. 6 is a cross-sectional view taken along the section line A2 in FIG. 1.

FIG. 7 is a cross-sectional view taken along the section line A2 in FIG. 1, while FIG. 6 and FIG. 7 are in different states.

FIG. 8 is a perspective schematic view of a connector assembly according to some other embodiments of the present disclosure.

FIG. 9 is a perspective schematic view of the connector assembly of FIG. 8 from another viewing angle.

FIG. 10 is an exploded view of the connector assembly of FIG. 8.

FIG. 11 is a perspective schematic view of a cable-end connector of the connector assembly of FIG. 8.

FIG. 12 is a cross-sectional view taken along the section line A3 in FIG. 8.

FIG. 13 is a perspective schematic view of some components of the connector assembly of FIG. 8, and some components are represented with dashed lines to indicate transparency.

FIG. 14 is a perspective schematic view of some components of the connector assembly of FIG. 8.

FIG. 15 is a perspective schematic view of the connector assembly of FIG. 8 from another viewing angle.

FIG. 16 is a cross-sectional view taken along the section line A4 in FIG. 8.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

To make the objectives, technical features, and advantages of the present disclosure clear and more understandable, a detailed description will be provided below in conjunction with the accompanying drawings. However, it should be understood that the specific embodiments described below are only for illustrating the present disclosure and not for limiting the scope of the present disclosure. In the specification and drawings, the same reference numerals generally represent the same or functionally similar parts. Furthermore, for convenience of description, a first axial direction X, a second axial direction Y, and a third axial direction Z will be defined as substantially perpendicular to each other, and the first axial direction X, the second axial direction Y, and the third axial direction Z will serve as a reference for describing the relative positions, arrangement relationships, and force directions of components.

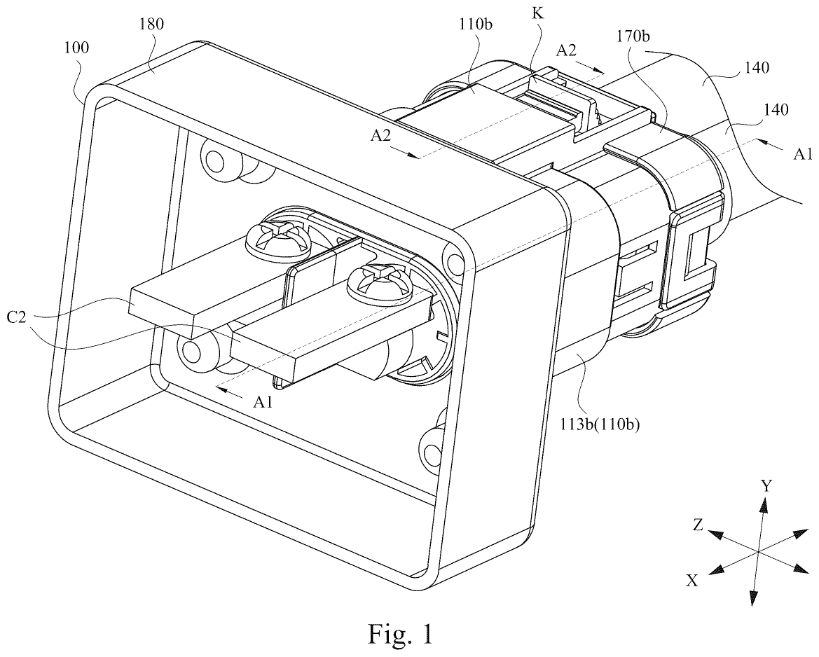

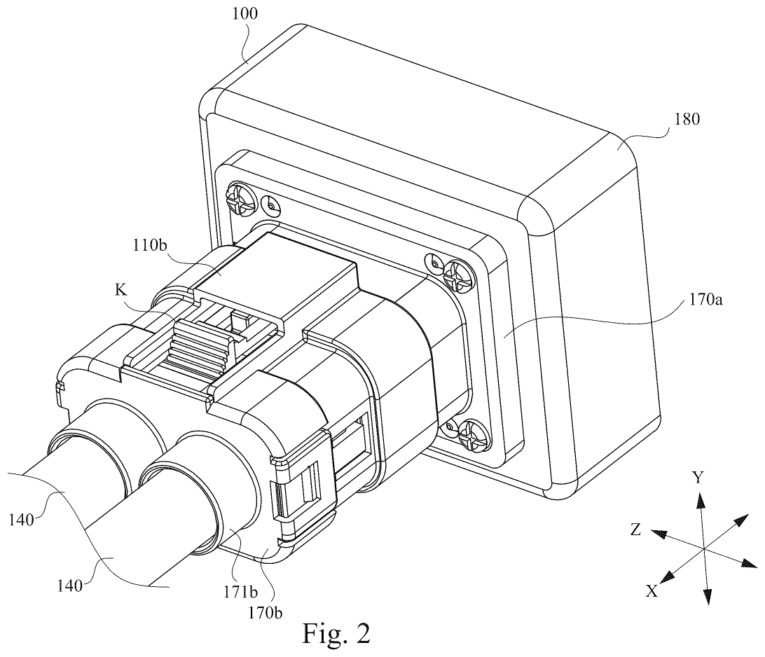

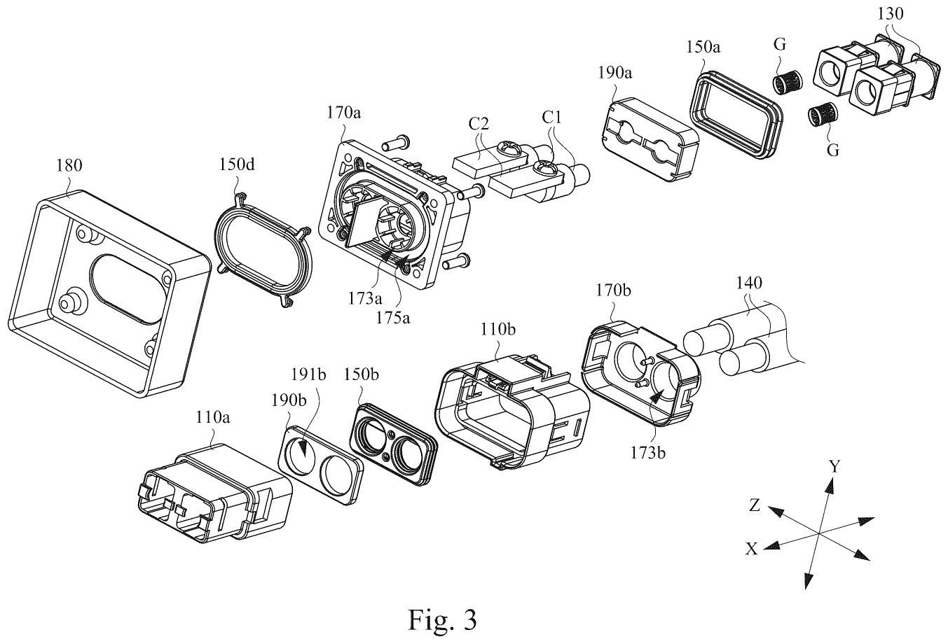

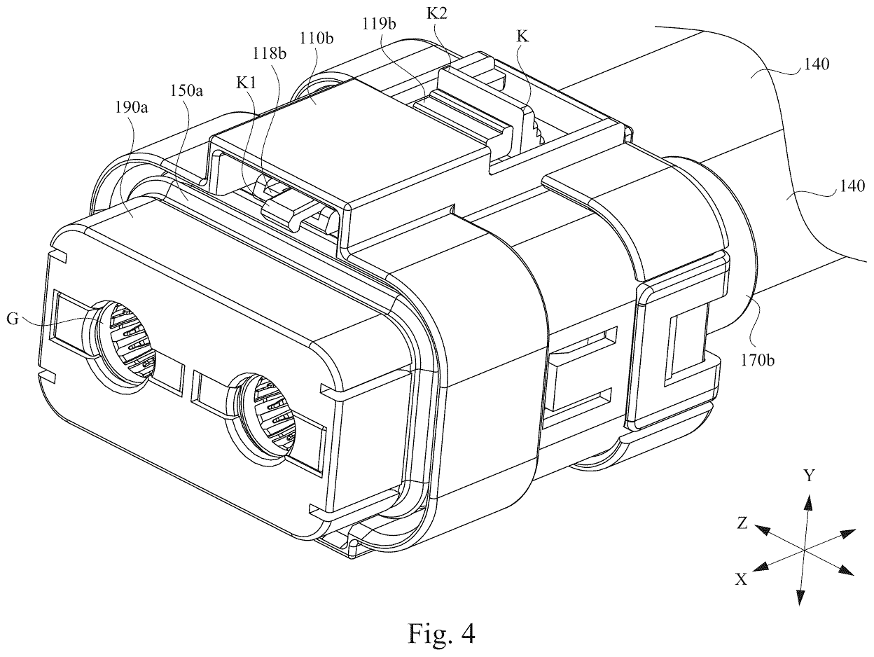

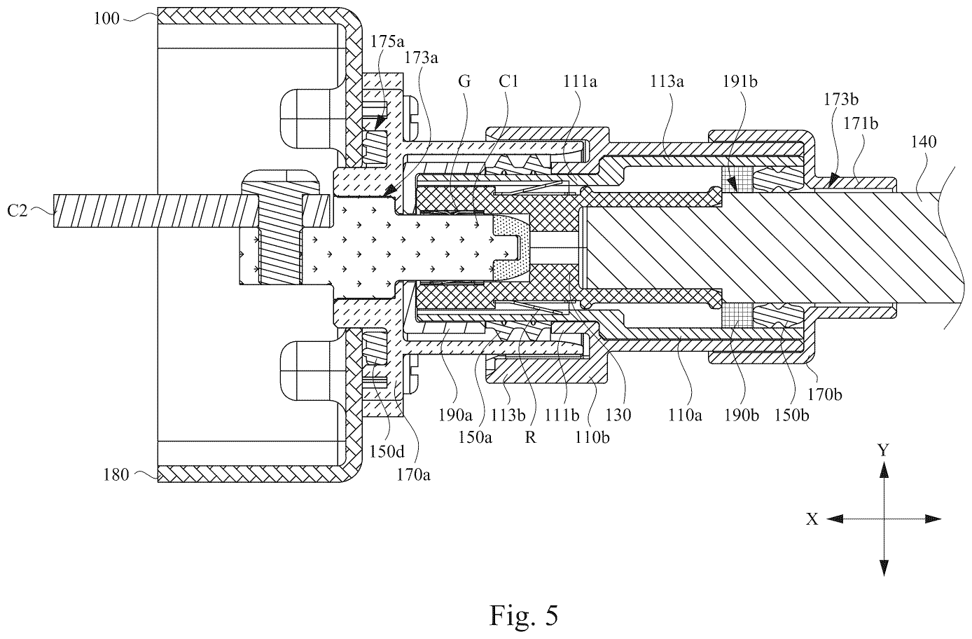

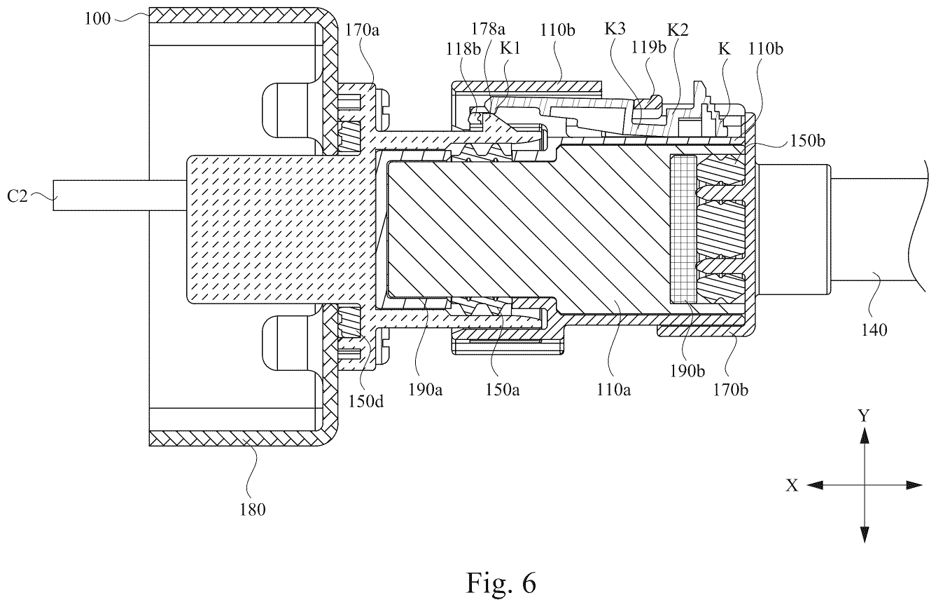

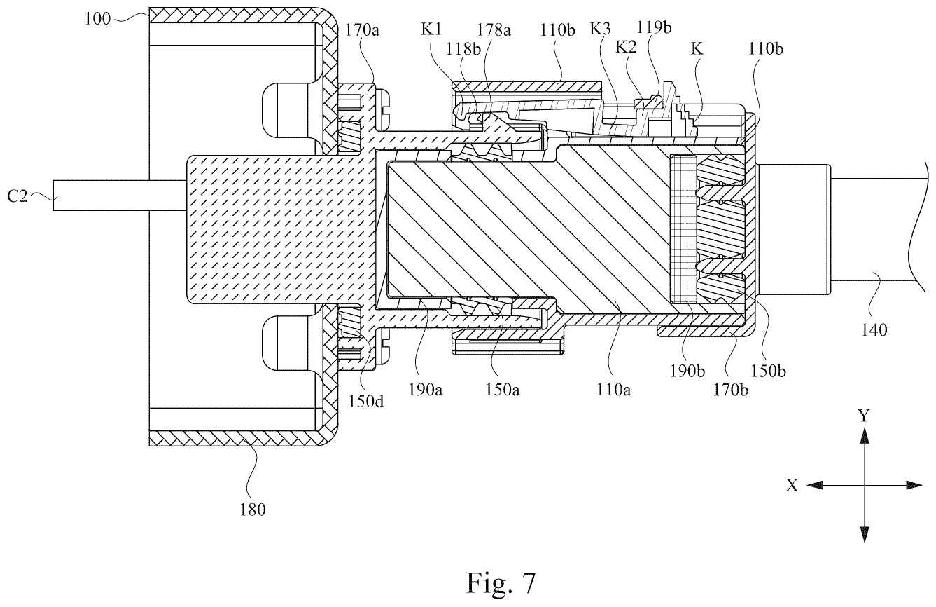

Please refer to FIGS. 1-7. FIG. 1 is a perspective schematic view of a connector assembly 100 according to some embodiments of the present disclosure. FIG. 2 is a perspective schematic view of the connector assembly 100 in FIG. 1 from another viewing angle. FIG. 3 is an exploded view of the connector assembly 100 in FIG. 1. FIG. 4 is a perspective schematic view of a cable-end connector of the connector assembly 100 in FIG. 1. FIG. 5 is a cross-sectional view taken along the section line A1 in FIG. 1. FIG. 6 is a cross-sectional view taken along the section line A2 in FIG. 1. FIG. 7 is a cross-sectional view taken along the section line A2 in FIG. 1, while FIG. 6 and FIG. 7 are in different states. In some embodiments of the present disclosure, the connector assembly 100 includes a cable-end connector and a mating connector. The cable-end connector includes a first housing 110a, a second housing 110b, a conductive base 130, a waterproof member 150a, and a stopping member 190a. The mating connector includes a front barrel 170a.

The first housing 110a has a tubular shape and extends along the first axial direction X, and the first housing 110a provides a space for accommodating internal components. In some embodiments, the first housing 110a includes a first sleeve portion 111a (or a mating zone) extending along the first axial direction X, and the first housing 110a can be made of an insulating material (e.g., plastic).

The conductive base 130 is made of a conductive material and is located within the first sleeve portion 111a of the first housing 110a, and the conductive base 130 is used to establish a conductive path and connect with other conductive elements.

The waterproof member 150a surrounds an outer peripheral surface of the mating zone (the first sleeve portion 111a) of the first housing 110a. The waterproof member 150a can be an annular sealing member made of an elastic material such as rubber or silicone. The waterproof member 150a can include multiple annular ribs, and an annular surface of each annular rib extends along a direction perpendicular to the first axial direction X so as to form a sealing interface between the first housing 110a and other components.

The second housing 110b surrounds the outer peripheral surface of the first housing 110a, and part of the second housing 110b surrounds an outer side of the waterproof member 150a. A mating gap might be formed between the second housing 110b and the waterproof member 150a, and the second housing 110b can be an exterior of the connector assembly 100 or function as an outer layer structure of the connector assembly 100.

The stopping member 190a is located in the mating zone of the first housing 110a and surrounds the outer peripheral surface of the first housing 110a. That is, on the Y-Z plane, the size of the stopping member 190a is larger than the size of the first sleeve portion 111a of the first housing 110a. Therefore, after the stopping member 190a is installed, the stopping member 190a extends from a front side of the first housing 110a to the outer peripheral surface on a lateral side of the first housing 110a. Specifically, the stopping member 190a is made of an insulating material (e.g., plastic), but the present disclosure is not limited thereto.

In some embodiments of the present disclosure, the stopping member 190a and the second housing 110b are respectively located on opposite sides of the waterproof member 150a along the first axial direction X. The waterproof member 150a is clamped between the stopping member 190a and the second housing 110b in the first axial direction X. The stopping member 190a and the second housing 110b cooperatively limit the waterproof member 150a. This limitation ensures that the waterproof member 150a is not easily detached, displaced, or damaged along the first axial direction X when used, and the waterproof member 150a can remain in a proper position to achieve a reliable waterproof effect.

The front barrel 170a of the mating connector is detachably connected to the first housing 110a and the second housing 110b of the cable-end connector. The front barrel 170a and the first housing 110a cooperatively define a waterproof space, and the front barrel 170a surrounds the first housing 110a and the waterproof member 150a. The waterproof member 150a is clamped between the front barrel 170a and the first housing 110a so as to seal a joint therebetween for preventing moisture or dust from entering the waterproof space. Particularly, an inner wall of the front barrel 170a is configured to apply a compressive force to the waterproof member 150a in a direction perpendicular to the first axial direction X, and the direction perpendicular to the first axial direction X is, for example, the second axial direction Y or the third axial direction Z. Since the waterproof member 150a is made of an elastic material, this compressive force will cause the waterproof member 150a to closely fit against the outer peripheral surface of the first housing 110a and an inner wall surface of the front barrel 170a, which can effectively form a waterproof barrier on the connector assembly 100 and prevent moisture or other contaminants from infiltrating. It should be noted that the stopping member 190a can prevent the waterproof member 150a from deforming or detaching from the first housing 110a when the front barrel 170a is detached from or assembled to the first housing 110a, thereby increasing the lifespan of the waterproof member 150a.

In some embodiments, the second housing 110b includes a first tubular portion 111b. This first tubular portion 111b extends along the first axial direction X and surrounds the outer peripheral surface of the first housing 110a. Furthermore, an opening of the first tubular portion 111b abuts the waterproof member 150a along the first axial direction X. At this time, the waterproof member 150a is limited between the first tubular portion 111b and the stopping member 190a, which can ensure that when the front barrel 170a is inserted, displacement of the waterproof member 150a due to frictional force with the front barrel 170a is avoided, thereby preventing impact on the waterproof effect and lifespan.

In some embodiments, the second housing 110b includes a second tubular portion 113b surrounding the first tubular portion 111b and being spaced apart from the first tubular portion 111b. When the front barrel 170a is inserted, the first tubular portion 111b and the second tubular portion 113b cooperatively clamp a portion of the front barrel 170a. An inner wall surface of this second tubular portion 113b abuts an outer surface of the front barrel 170a in a direction perpendicular to the first axial direction X, and the direction perpendicular to the first axial direction X is, for example, the second axial direction Y or the third axial direction Z. Furthermore, the second tubular portion 113b, the front barrel 170a, and the waterproof member 150a are arranged sequentially from an exterior to an interior. In addition to protecting the front barrel 170a and the waterproof member 150a, the second tubular portion 113b is beneficial for maintaining structural stability and transmitting sealing force. In detail, the second tubular portion 113b applies the sealing force to the front barrel 170a and then transmits the sealing force to the waterproof member 150a.

In some embodiments, the connector assembly 100 further includes one or more contact springs R. The contact spring R is located on the conductive base 130. To ensure that the conductive base 130 is stably fixed within the first housing 110a, the contact spring R is designed to engage with specific structural features of the first housing 110a (e.g., a recessed structure or a latching groove on an inner wall surface of the first sleeve portion 111a). This engagement mechanism can effectively combine the first housing 110a with the conductive base 130, thereby preventing displacement under external forces and ensuring overall structural stability. During the process of inserting the conductive base 130 into the first housing 110a, the inner wall surface of the first housing 110a will apply force to the contact spring R and cause the contact spring R to elastically deform. When the contact spring R moves to a recessed structure of the first housing 110a, the contact spring R elastically recovers and moves towards the first housing 110a, thereby being engaged into the recessed structure.

Please refer to FIGS. 1-7. In some embodiments, to further improve its waterproof performance, the mating connector of the connector assembly 100 further includes a sealing ring 150d and a cap 180. The front barrel 170a includes an accommodating cavity 173a and an annular receiving groove 175a surrounding the accommodating cavity 173a. The sealing ring 150d is located in the annular receiving groove 175a. The cap 180 covers an opening of the annular receiving groove 175a, and the cap 180 abuts and compresses the sealing ring 150d. By applying force to the sealing ring 150d via the cap 180 (e.g., using screws to lock the cap 180 to the front barrel 170a), a reliable seal can be formed between the cap 180 and the front barrel 170a so as to protect internal components.

In some embodiments of the present disclosure, the mating connector of the connector assembly 100 further includes a conductive body C1 and a contact piece C2. The conductive body C1 is columnar and located in the accommodating cavity 173a. The conductive body C1 is configured to electrically connect to the conductive base 130. The contact piece C2 is located outside the accommodating cavity 173a and used to connect to external components. The conductive body C1 and the contact piece C2 can be made of metal or alloy. The conductive body C1 and the contact piece C2 can be interconnected by appropriate fixing means (e.g., screw locking). To ensure a stable and reliable electrical connection between the conductive body C1 and the conductive base 130, the connector assembly 100 further includes a crown spring G. The crown spring G is an annular elastic structure with multiple elastic contact points. The crown spring G is typically located within a receiving hole of the conductive base 130 so as to surround the conductive body C1. When the conductive body C1 is inserted into the conductive base 130, the crown spring G is compressed by the conductive body C1 and elastically deforms. At this point, the crown spring G is located between the conductive body C1 and the conductive base 130, and the crown spring G is stably electrically connected between the conductive body C1 and the conductive base 130. In some embodiments, the cap 180 has an annular side wall (e.g., a square annular shape), and this annular side wall surrounds the contact piece C2 and protects the contact piece C2 from collision with external objects.

In some embodiments of the present disclosure, the cable-end connector of the connector assembly 100 includes the first housing 110a, the conductive base 130, a cable 140, a waterproof member 150b, a rear barrel 170b, and a stopping member 190b.

The first housing 110a also includes a second sleeve portion 113a extending along the first axial direction X. The second sleeve portion 113a communicates with the first sleeve portion 111a. An inner diameter/outer diameter of the second sleeve portion 113a is larger than an inner diameter/outer diameter of the first sleeve portion 111a. The conductive base 130 is located within the first sleeve portion 111a and the second sleeve portion 113a.

The cable 140 is at least partially located within the second sleeve portion 113a and electrically connected to the conductive base 130. The cable 140 can include conductive wires and an insulating coating covering the conductive wires.

The waterproof member 150b is located within the first housing 110a (e.g., within the second sleeve portion 113a). The waterproof member 150b surrounds the cable 140 and serves as a main sealing waterproof element. Specifically, the waterproof member 150b can be made of an elastic material such as rubber or silicone, and the waterproof member 150b includes a square outer frame and a circular receiving hole, but the present disclosure is not limited thereto. The circular receiving hole is provided corresponding to the cable 140, and the shape of the circular receiving hole corresponds to the shape of the cable 140 and is slightly smaller than the shape of the cable 140. Therefore, when the cable 140 passes through the circular receiving hole of the waterproof member 150b, there are no gaps therebetween, thereby achieving a waterproof effect.

The rear barrel 170b is coupled to the first housing 110a and surrounds the cable 140. The rear barrel 170b serves as a rear waterproof cover for the connector assembly 100. The rear barrel 170b and the first housing 110a cooperatively define a waterproof space.

The stopping member 190b is located within the second sleeve portion 113a and abuts the conductive base 130. The stopping member 190b surrounds the cable 140. Specifically, the stopping member 190b is made of an insulating material (e.g., plastic), but the present disclosure is not limited thereto.

In some embodiments of the present disclosure, the stopping member 190b and the rear barrel 170b are respectively located on opposite sides of the waterproof member 150b in the first axial direction X. That is, the stopping member 190b and the rear barrel 170b cooperatively provide positional limitation to the waterproof member 150b in the first axial direction X, preventing the waterproof member 150b from being displaced, deformed, or damaged under external forces (e.g., when pulling the cable 140). The stopping member 190b includes a through-hole 191b extending along the first axial direction X. The through-hole 191b is formed corresponding to the circular receiving hole of the waterproof member 150b. That is, the through-hole 191b is aligned with the circular receiving hole of the waterproof member 150b along the first axial direction X, and the through-hole 191b has the same or similar shape as the circular receiving hole of the waterproof member 150b. The rear barrel 170b includes a sleeve portion 171b extending along the first axial direction X. The sleeve portion 171b has a through-hole 173b. The cable 140 extends through this through-hole 173b of the sleeve portion 171b. Similarly, the through-hole 173b of the sleeve portion 171b corresponds to the circular receiving hole of the waterproof member 150b. That is, the through-hole 173b is aligned with the circular receiving hole of the waterproof member 150b along the first axial direction X, and the through-hole 173b has the same or similar shape as the circular receiving hole of the waterproof member 150b. Therefore, the cable 140 sequentially passes through the through-hole 173b of the sleeve portion 171b, the circular receiving hole of the waterproof member 150b, and the through-hole 191b. An inner wall of the through-hole 191b and an inner wall of the rear barrel 170b abut the cable 140 and support/limit the cable 140 in a direction perpendicular to the first axial direction X, and the direction perpendicular to the first axial direction X is, for example, the second axial direction Y or the third axial direction Z. This support is beneficial for maintaining the position of the cable 140 and preventing the cable 140 from moving along a direction perpendicular to the first axial direction X under forces which could cause gaps formed between the circular receiving hole of the waterproof member 150b and the cable 140. At the same time, the first housing 110a (e.g., an inner wall of the second sleeve portion 113a) is configured to compress an outer surface of the waterproof member 150b in a direction perpendicular to the first axial direction X, and the direction perpendicular to the first axial direction X is, for example, the second axial direction Y or the third axial direction Z, thereby forcing the waterproof member 150b to closely fit an outer surface of the cable 140 and an inner wall of the first housing 110a so as to form a reliable waterproof seal.

The stopping member 190b and the sleeve portion 171b are respectively located on opposite sides of the waterproof member 150b and can both support the cable 140. Therefore, the stopping member 190b and the sleeve portion 171b can maintain the cable 140 positioned stably from multiple directions, thereby preventing the cable 140 from wobbling and deteriorating the waterproof function of the waterproof member 150b. In addition, the stopping member 190b is located at a front end of the cable 140 (the end of the cable 140 close to the conductive base 130) and has a certain thickness (i.e. the stopping member 190b is thick enough to compensate for the size of the cable 140) in the first axial direction X. This is beneficial for compensating for insufficient tolerance or dimensional changes of the cable 140 due to manufacturing process (such as crimping), and it can ensure that the through-hole 191b of the stopping member 190b keeps abutting an insulating coating of the cable 140, thereby ensuring the sufficient support on the cable 140.

In some embodiments of the present disclosure, the connector assembly 100 further includes a latching member K, which is used to fix the mated cable-end connector and mating connector to each other. The second housing 110b has a latching portion 118b and an unlocking portion 119b connected with the latching portion 118b, and the latching portion 118b and the unlocking portion 119b can move along the first axial direction X. The front barrel 170a includes a protruding portion 178a. When the cable-end connector and the mating connector are mated, this protruding portion 178a engages with the latching portion 118b (locked state) for fixing the cable-end connector and the mating connector to each other. When the unlocking portion 119b is pressed, the latching portion 118b disengages from the protruding portion 178a, thereby allowing the cable-end connector and the mating connector to be separated. Therefore, the latching member K is designed to be detachably latched to the unlocking portion 119b.

The latching member K includes a hook portion K1, a stepped abutting portion K2, and an L-shaped connecting portion K3 connected to the hook portion K1 and the stepped abutting portion K2. The L-shaped connecting portion K3 is located between the hook portion K1 and the stepped abutting portion K2. In the locked state, the latching member K moves along the first axial direction X, so that the stepped abutting portion K2 moves to a position below the unlocking portion 119b, and the hook portion K1 hooks a front end of the latching portion 118b for fixing the position of the latching member K. At this time, the unlocking portion 119b cannot be pressed easily. Therefore, it can prevent the unlocking portion 119b from being accidentally pressed, which would cause the cable-end connector and the mating connector to separate. When a user intends to separate the cable-end connector and the mating connector, the latching member K is first moved in a reverse direction of the first axial direction X, so that the hook portion K1 disengages from the front end of the latching portion 118b and the stepped abutting portion K2 moves away from the position below the unlocking portion 119b. At this time, the unlocking portion 119b resumes its pressing function, and the cable-end connector and the mating connector can be separated. Through the elaborate structural cooperation among the latching member K, the latching portion 118b, and the unlocking portion 119b, the latching member K, the cable-end connector, and the mating connector can achieve stable fixation, thereby firmly fixing the overall structure.

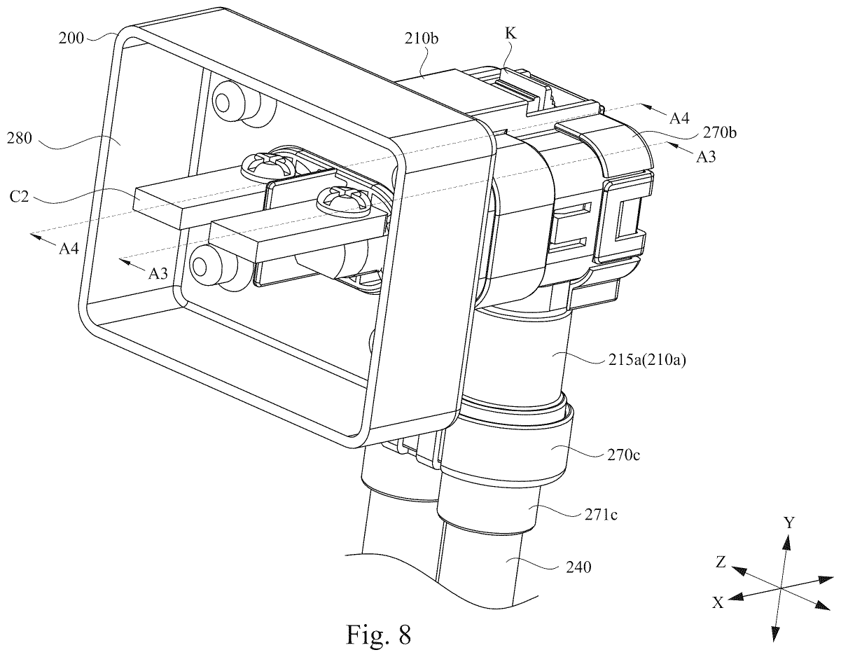

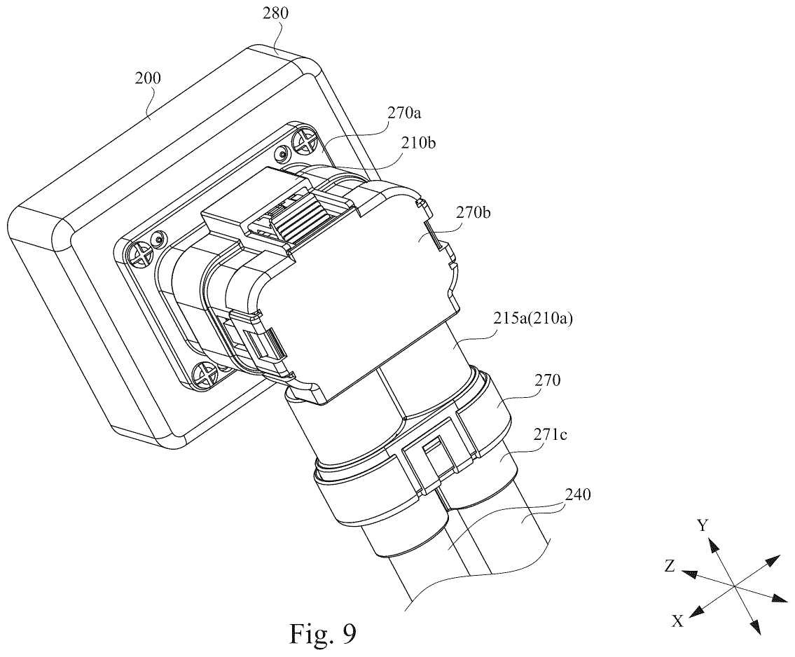

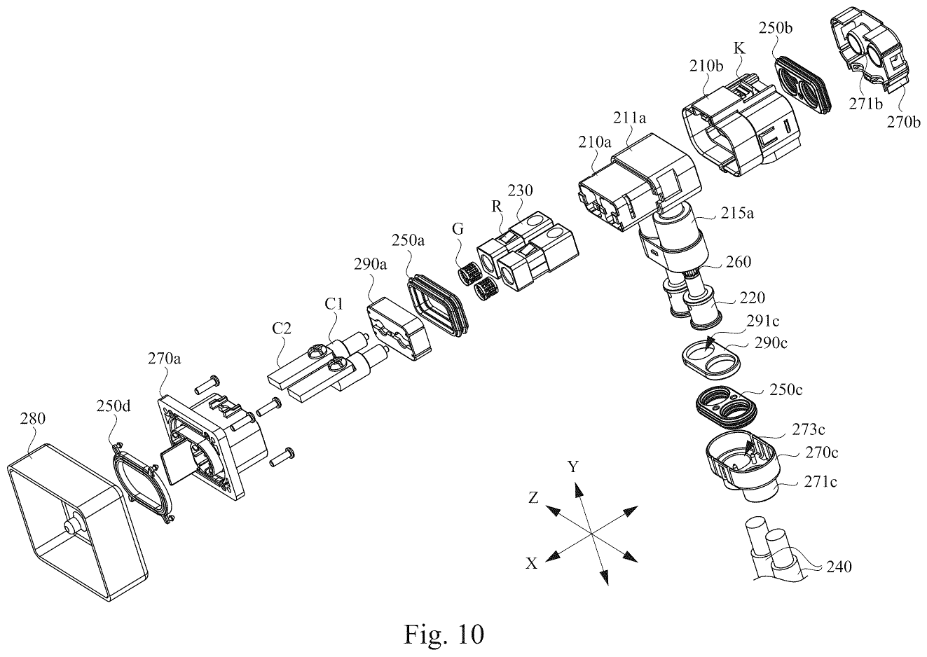

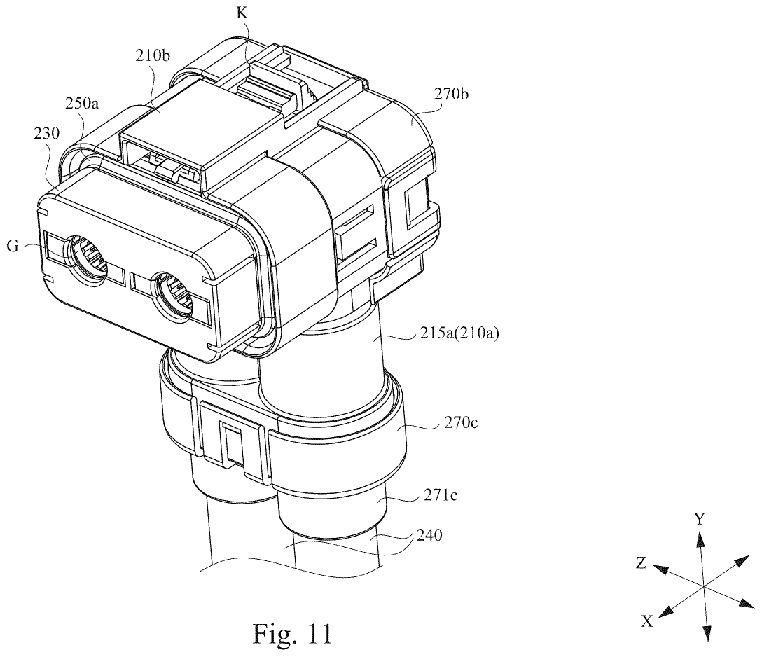

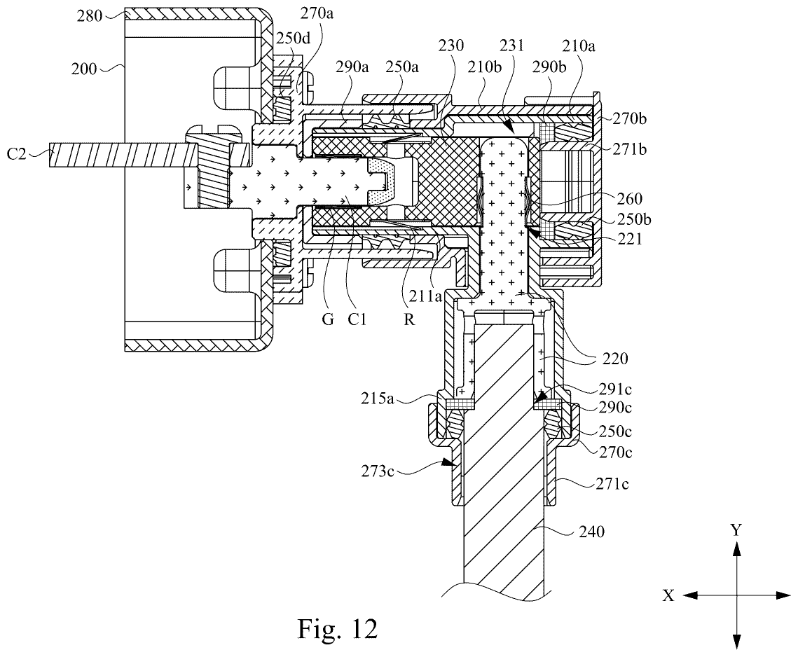

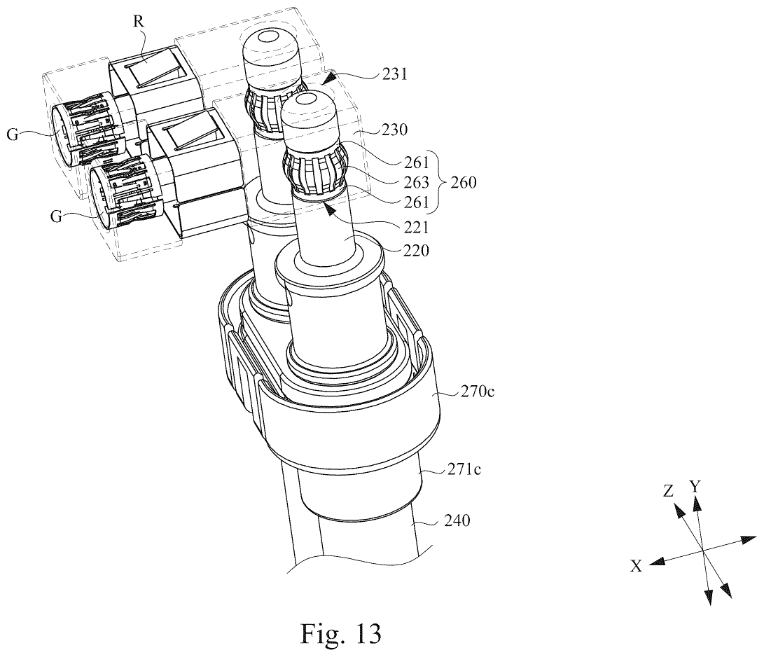

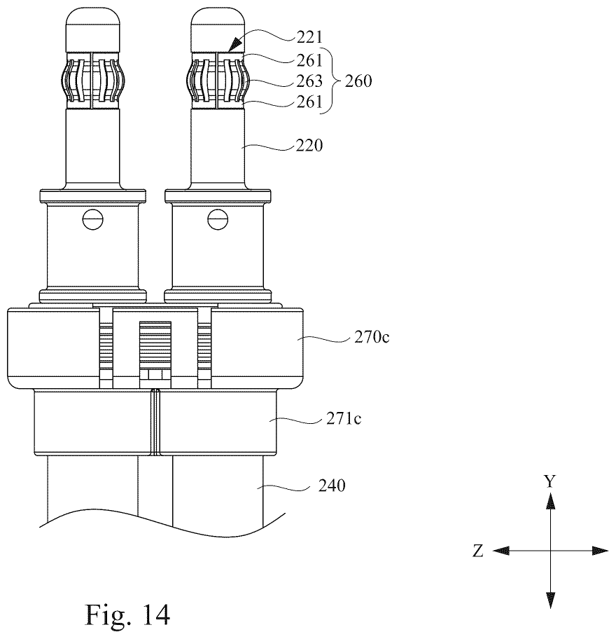

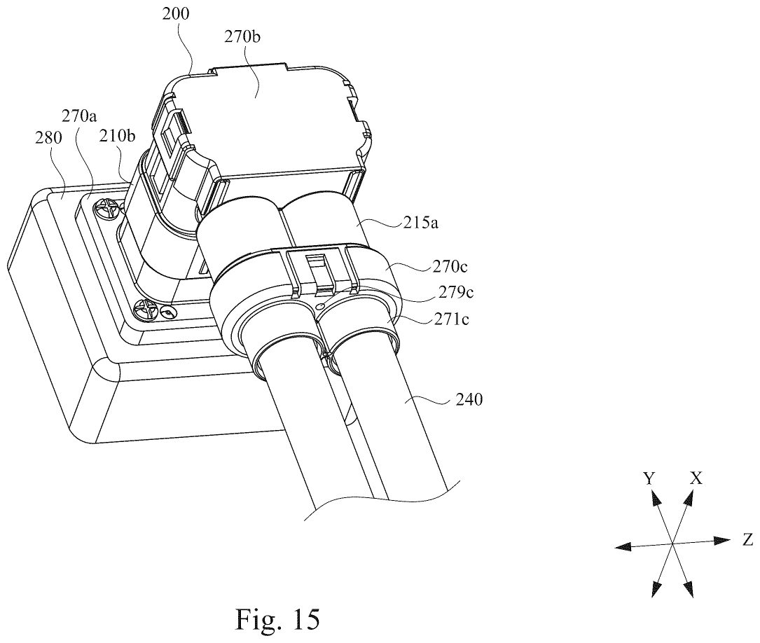

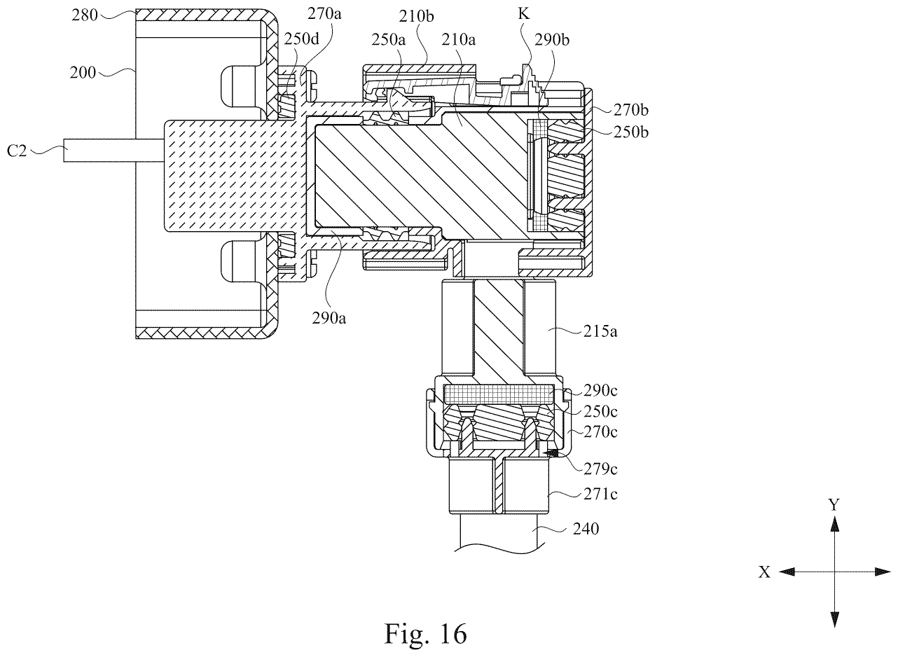

Please refer to FIGS. 8-16 simultaneously. FIGS. 8-16 provide a cable-end connector (please refer specifically to FIG. 11) and a connector assembly 200 including this cable-end connector. FIG. 8 is a perspective schematic view of a connector assembly 200 according to other embodiments of the present disclosure. FIG. 9 is a perspective schematic view of the connector assembly 200 in FIG. 8 from another viewing angle. FIG. 10 is an exploded view of the connector assembly 200 in FIG. 8. FIG. 11 is a perspective schematic view of the cable-end connector of the connector assembly 200 in FIG. 8. FIG. 12 is a cross-sectional view taken along the section line A3 in FIG. 8. FIG. 13 is a perspective schematic view of some components of the cable-end connector in FIG. 8, and some components are represented with dashed lines to indicate transparency. FIG. 14 is a perspective schematic view of some components of the cable-end connector in FIG. 8. FIG. 15 is a perspective schematic view of the connector assembly 200 in FIG. 8 from another viewing angle. FIG. 16 is a cross-sectional view taken along the section line A4 in FIG. 8. In some embodiments of the present disclosure, the connector assembly 200 includes a cable-end connector and a mating connector. The cable-end connector includes a first housing 210a, a second housing 210b, a conductive plug 220, a conductive base 230, a cable 240, a waterproof member 250a, a waterproof member 250b, a waterproof member 250c, a rear barrel 270b, a lateral barrel 270c, a stopping member 290a, a stopping member 290b, a stopping member 290c, a crown spring G, a latching member K, and a contact spring R. The mating connector includes a sealing ring 250d, a front barrel 270a, a cap 280, a conductive body C1, and a contact piece C2. The concept and design of the connector assembly 200 are similar to those of the connector assembly 100, and the main difference is that the cable 240 of the connector assembly 200 is assembled to a lateral side of the connector assembly 200. The following will introduce this main difference and related details.

The first housing 210a includes a tubular main body 211a and a sleeve portion 215a extending from a lateral side of the main body 211a, and the main body 211a extends along the first axial direction X while the sleeve portion 215a extends along the second axial direction Y.

The conductive plug 220 is located within the sleeve portion 215a of the first housing 210a. The conductive plug 220 can be made of a conductive material and electrically connected to the conductive base 230 located within the main body 211a.

The conductive base 230 is substantially the same as the conductive base 130. The conductive base 230 is located within the main body 211a. The conductive base 230 includes a hole 231 extending along the second axial direction Y and passing through a top end and a bottom end of the conductive base 230. Furthermore, the conductive plug 220 is inserted into the conductive base 230, and the conductive plug 220 electrically contacts the hole 231 of the conductive base 230. The hole 231 can limit the conductive plug 220 in the first axial direction X, thus making it difficult for external forces to detach the conductive plug 220 from the conductive base 230 along the first axial direction X.

The cable 240 (substantially the same as the cable 140) is at least partially located within the sleeve portion 215a of the first housing 210a. The cable 240 is electrically connected to the conductive plug 220. In this way, a conductive path can be established from the cable 240 through the conductive plug 220 to the conductive base 230.

The waterproof member 250c is located within the sleeve portion 215a and surrounds the cable 240 so as to provide a sealing function. Specifically, the waterproof member 250c is annular and made of an elastic material (e.g., rubber or silicone).

The lateral barrel 270c is coupled to the sleeve portion 215a of the first housing 210a and serves as a side waterproof cover for the connector assembly 200. The lateral barrel 270c and the sleeve portion 215a cooperatively define a waterproof space, and the lateral barrel 270c surrounds the cable 240 so as to provide a waterproof function.

The stopping member 290c is also located within the sleeve portion 215a. The stopping member 290c abuts one end of the conductive plug 220, and the stopping member 290c surrounds the cable 240. The stopping member 290c is made of an insulating material, but the present disclosure is not limited thereto.

In some embodiments, the stopping member 290c and the lateral barrel 270c are respectively located on opposite sides of the waterproof member 250c in the second axial direction Y. That is, the stopping member 290c and the lateral barrel 270c cooperatively provide positional limitation and/or compressive force to the waterproof member 250c in the second axial direction Y, which can prevent displacement of the waterproof member 250c. At the same time, the sleeve portion 215a of the first housing 210a is configured to compress the waterproof member 250c in a direction perpendicular to the second axial direction Y, and the direction perpendicular to the second axial direction Y is, for example, the first axial direction X and the third axial direction Z. This compression causes the waterproof member 250c to closely fit an outer surface of the cable 240 and an inner wall of the sleeve portion 215a, thereby forming a reliable waterproof seal.

In some embodiments, to ensure a stable and reliable low-impedance electrical connection between the conductive plug 220 and the conductive base 230, the connector assembly 200 further includes an elastic conductive member 260. The elastic conductive member 260 surrounds the conductive plug 220 (e.g., the elastic conductive member 260 is sleeved onto the conductive plug 220). This elastic conductive member 260 is configured to be pressed by the hole 231 of the conductive base 230 and to closely abut an outer surface of the conductive plug 220. Subjected to this compressive force, the elastic conductive member 260 can provide a low-impedance electrical connection between the conductive plug 220 and the conductive base 230.

Specifically, the elastic conductive member 260 may be in a lantern shape (which is, for example, basically a barrel shape with a greater diameter at the middle portion and a smaller diameter at the two ends). The elastic conductive member 260 includes two substantially parallel annular end portions 261 and at least one bent portion 263 (e.g., a plurality of rib-like bent portions 263) located between the two end portions 261. In the assembled state of FIG. 11, an inner wall of the hole 231 of the conductive base 230 contacts and presses the bent portions 263.

In some embodiments, the conductive plug 220 includes a groove 221. The groove 221 extends on an outer surface of the conductive plug 220, and the conductive plug extends along the second axial direction Y. The two end portions 261 of the elastic conductive member 260 respectively abut two parallel wall surfaces of the groove 221. These two wall surfaces face each other and extend perpendicularly to the second axial direction Y, so that the groove 221 can position the elastic conductive member 260 on the conductive plug 220 via the two wall surfaces.

In some embodiments, the lateral barrel 270c includes a sleeve portion 271c. This sleeve portion 271c extends along the second axial direction Y, and the sleeve portion 271c surrounds the cable 240. The sleeve portion 271c is used to support the cable 240 in a direction perpendicular to the second axial direction Y.

In some embodiments, the stopping member 290c includes a through-hole 291c extending along the second axial direction Y (please refer specifically to FIG. 8 and FIG. 10). The through-hole 291c surrounds the cable 240, and an inner wall of the through-hole 291c is used to support the cable 240 in a direction perpendicular to the second axial direction Y. The sleeve portion 271c and the through-hole 291c are respectively located on opposite sides of the waterproof member 250c in the second axial direction Y. A through-hole 273c of the sleeve portion 271c, the through-hole 291c, and a receiving hole of the waterproof member 250c are aligned along the second axial direction Y, such that the cable 240 can sequentially pass through the sleeve portion 271c (the through-hole 273c), the receiving hole of the waterproof member 250c, and the through-hole 291c. With such an arrangement, the cooperative effect provided by the sleeve portion 271c and the through-hole 291c can maintain the cable 240 positioned stably, which can prevent gaps formed between the waterproof member 250c and the cable 240 caused by external forces (e.g., pulling force on the cable 240), thereby maintaining the waterproof function.

In some embodiments, to further enhance waterproof and moisture-proof capabilities, the connector assembly 200 further includes an insulating material. This insulating material covers a connection portion of the cable 240 and the conductive plug 220 (e.g., the insulating material completely covers a rear end of the conductive plug 220 as well as the exposed conductive wires and a portion of the insulating coating of the cable 240). This insulating material can provide an additional moisture-proof barrier, supplementing the sealing effect of the waterproof member 250c.

In some embodiments, the cable-end connector may omit the waterproof member 250c and the stopping member 290c. Instead, a through-hole 279c (please refer to FIG. 13, FIG. 14 and FIG. 15) is provided on the lateral barrel 270c and is used as an injection hole. The through-hole 279c is used to inject a liquid insulating material or a semi-liquid insulating material to fill a space between the sleeve portion 215a and the lateral barrel 270c. After the insulating material solidifies, it forms a protective structure so as to provide a waterproof function.

Please refer to FIG. 8 to FIG. 16. Compared with the connector assembly 100 in the embodiment of FIG. 1, since the cable 240 is connected to the cable-end connector of the connector assembly 200 from a lateral side of the connector assembly 200, the cable-end connector has an alternative rear barrel 270b and other components. In some embodiments of the present disclosure, the cable-end connector includes the first housing 210a, the second housing 210b, the conductive base 230, the waterproof member 250b, the rear barrel 270b, and the stopping member 290b. The first housing 210a, the second housing 210b, and the conductive base 230 are introduced above, and therefore will not be repeatedly described.

The waterproof member 250b can be an annular sealing member made of an elastic material such as rubber or silicone.

The rear barrel 270b serves as a rear waterproof cover for the connector assembly 200. The rear barrel 270b is coupled to the first housing 210a and the second housing 210b. The rear barrel 270b includes a sleeve portion 271b extending along the first axial direction X.

The stopping member 290b is made of an insulating material and located within the first housing 210a. The stopping member 290b surrounds the sleeve portion 271b and abuts the conductive base 230.

In some embodiments of the present disclosure, the stopping member 290b and the rear barrel 270b are respectively located on opposite sides of the waterproof member 250b in the first axial direction X. The waterproof member 250b and the stopping member 290b surround the sleeve portion 271b. An inner wall of the first housing 210a and an outer wall of the sleeve portion 271b cooperatively compress the waterproof member 250b in a direction perpendicular to the first axial direction X, thereby the first housing 210a and the rear barrel 270b cooperatively defining a waterproof space. The stopping member 290b is arranged at a front end of the sleeve portion 271b, which can provide a waterproof function and further compensate for dimensional errors of the sleeve portion 271b caused by manufacturing processes, thereby avoiding water leakage due to insufficient sealing. For instance, the front end of the sleeve portion 271b abuts the conductive base 230. Thus, based on the clever combination of the stopping member 290b and the waterproof member 250b, the first housing 210a and the rear barrel 270b can provide a stable and effective means of waterproofing solution for the connector assembly 200.

In summary, the cable-end connector and the connector assembly of the present disclosure achieve effective waterproof sealing through the combination and interaction of elaborately designed structures, such as the housings, the conductive elements, the waterproof members, the barrels, and the stopping members. Some embodiments further incorporate additional technical means, such as the contact spring, the sealing rings, the elastic conductive members, and the insulating material to further improve structural stability, electrical connection reliability, and overall waterproof capability. These designs aim to ensure that the cable-end connector can operate stably for a long term in various environments.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A connector assembly comprising:
a cable-end connector comprising:
a first housing having a tubular shape;
a conductive base disposed within the first housing;
a first waterproof member surrounding an outer peripheral surface of the first housing;
a second housing surrounding the outer peripheral surface of the first housing;
a first stopping member surrounding the outer peripheral surface of the first housing, wherein the first stopping member and the second housing are located on opposite sides of the first waterproof member respectively in an axial direction and cooperatively limit the first waterproof member therebetween;
at least one cable electrically connected to the conductive base;
a second waterproof member having at least one receiving hole;
a second stopping member having at least one through-hole; and
a rear barrel having at least one through-hole, wherein the receiving hole is aligned with the at least one through-hole of the rear barrel and the through-hole of the second stopping member, such that the at least one cable is configured to pass sequentially through the rear barrel, the second waterproof member, and the second stopping member; and
a mating connector comprising:
a front barrel detachably connected to the first housing and cooperatively defining a waterproof space with the first housing, wherein the front barrel surrounds the first housing and the first waterproof member, and an inner wall of the front barrel is configured to apply force to the first waterproof member in a direction perpendicular to the axial direction.

2. The connector assembly of claim 1, wherein the second housing comprises a first tubular portion surrounding the outer peripheral surface of the first housing, an opening of the first tubular portion abuts the first waterproof member along the axial direction.

3. The connector assembly of claim 1, wherein the second housing comprises a second tubular portion, an inner wall surface of the second tubular portion abuts the front barrel in the direction perpendicular to the axial direction.

4. The connector assembly of claim 3, wherein the second tubular portion, the front barrel, and the first waterproof member are arranged sequentially from an exterior to an interior.

5. The connector assembly of claim 1, further comprising a contact spring disposed on the conductive base and engaged with the first housing.

6. The connector assembly of claim 1, wherein the mating connector further comprises a sealing ring and a cap, the front barrel comprises an annular receiving groove, the sealing ring is disposed in the annular receiving groove, and the cap covers the annular receiving groove and compresses the sealing ring.

7. A cable-end connector comprising:
a housing having a tubular shape;
a conductive base disposed within the housing;
a cable at least partially disposed within the housing and electrically connected to the conductive base;
a rear barrel coupled to the housing and cooperatively defining a waterproof space with the housing, wherein the rear barrel surrounds the cable;
a waterproof member disposed within the housing and surrounding the cable; and
a stopping member disposed within the housing and abutting the conductive base, wherein the stopping member surrounds the cable, the stopping member and the rear barrel are respectively disposed on opposite sides of the waterproof member in an axial direction and cooperatively limit the waterproof member therebetween in the axial direction, and the housing is configured to compress the waterproof member in a direction perpendicular to the axial direction.

8. The cable-end connector of claim 7, wherein the stopping member comprises a through-hole abutting the cable and supporting the cable in the direction perpendicular to the axial direction.

9. The cable-end connector of claim 7, wherein the rear barrel comprises a sleeve portion surrounding the cable and supporting the cable in the direction perpendicular to the axial direction.

10. A cable-end connector comprising:
a housing comprising a main body and a sleeve portion extending from a lateral side of the main body;
a conductive base disposed within the housing;
a conductive plug disposed within the sleeve portion and electrically connected to the conductive base;
a cable at least partially disposed within the sleeve portion and electrically connected to the conductive plug;
a waterproof member disposed within the sleeve portion and surrounding the cable;
a lateral barrel coupled to the sleeve portion and cooperatively defining a waterproof space with the sleeve portion, wherein the lateral barrel surrounds the cable; and
a stopping member disposed within the sleeve portion and abutting the conductive plug, wherein the stopping member surrounds the cable, the stopping member and the lateral barrel are respectively disposed on opposite sides of the waterproof member in an axial direction and cooperatively limit the waterproof member therebetween in the axial direction, and the sleeve portion is configured to compress the waterproof member in a direction perpendicular to the axial direction.

11. The cable-end connector of claim 10, further comprising an elastic conductive member surrounding the conductive plug and configured to be pressed by a recess of the conductive base to abut the conductive plug.

12. The cable-end connector of claim 11, wherein the elastic conductive member further comprises two end portions and at least one bent portion located between the two end portions, the conductive base contacts the at least one bent portion.

13. The cable-end connector of claim 11, wherein the elastic conductive member further comprises two end portions and at least one bent portion located between the two end portions, the conductive plug further comprises a groove, and the two end portions respectively abut two parallel wall surfaces of the groove.

14. The cable-end connector of claim 10, wherein the stopping member comprises a through-hole extending along the axial direction and receiving the cable.

15. The cable-end connector of claim 10, wherein the lateral barrel comprises a sleeve portion extending along the axial direction and is configured to receive the cable.

16. The cable-end connector of claim 10, further comprising an insulating material covering a portion of the cable.
